(19) United States
(12) Patent Application Publication
(10) Pub. No.: US 2006/0236310 A1
(43) Pub. Date: Oct. 19, 2006

(54) Methods and apparatus to iteratively compile software to meet user-defined criteria

(76) Inventors: Max J. Domeika, Sherwood, OR (US); Mohammad R. Haghighat, San Jose, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/109,142

(22) Filed: Apr. 19, 2005

(51) Int. Cl. G06F 9/45

(52) U.S. Cl. 717/140

(57) ABSTRACT

Methods, apparatus, and articles of manufacture to iteratively compile software to meet user-defined criteria are disclosed. A disclosed example method receives target performance characteristics from a user and compiles source code to generate object code. The object code is then analyzed to determine measured performance characteristics. The measured performance characteristics are then compared to the target performance characteristics. If the measured performance characteristics are unacceptable based on the target performance characteristics, the one of a plurality of compiler options configurations is selected based on empirical data correlating the compiler options configurations to structural characteristics of at least one of the source code or the object code. Without obtaining further user input, the operations are repeated one or more times until the measured performance characteristics are substantially equal to the target performance characteristics or until a predetermined number of recompilations have occurred.

### FIELD OF THE DISCLOSURE

The present disclosure relates generally to compilers and, more particularly, to methods, apparatus, and articles of manufacture to iteratively compile software to meet user-defined criteria.

### BACKGROUND

Software compilers have several optimization capabilities. Some compiler capabilities include user selectable compiler options that enable the compiler to optimize object code with respect to different, sometimes competing, performance criteria. For example, some compiler options are associated with optimizing object code for increased execution speed (i.e., decreased execution time). In this case, the compiler may compile source code so that execution speed is regarded as the most important parameter to optimize and code size is regarded as a less important characteristic of the resulting object code.

Typically, compiler options are selected by a user (e.g., a programmer) by setting switches or flags in a compiler application prior to compiling the source code. The compiler then compiles the source code while attempting to generate object code that meets the criteria specified in the selected compiler options. If a user is not satisfied with the performance of the resulting object code, the user may select different compiler options or configure the compiler to focus on optimizing particular code modules or areas in the source code. This process of selecting and reselecting the compiler options can be an iterative process that is repeated until the user is satisfied with the level of optimization of the object code. To be effective, this process typically requires a skilled person or programmer that is intimately familiar with the capabilities of the compiler and compiler options so that the person can select or change the compiler options to achieve the desired optimization results.

Some recently developed compilers attempt to improve the above-noted compiler option selection process by compiling source code based on desired performance criteria specified by a user via a user interface. For example, a user may specify that the compiler should reduce the binary code size of object code by a particular percentage. The user may alternatively or additionally specify that the compiler should increase the execution speed of the object code by a particular percentage. Although this simplifies a user's burden of selecting compiler options, traditional compilers lack a feedback mechanism for users to make informed optimization decisions. In addition, these compilers lack the capability to inform users how certain optimizations will affect other performance aspects of object code. Further, traditional compilers require that users manually adjust optimization options and performance criteria following each compilation until the compiler generates object code having acceptable performance.

### BRIEF DESCRIPTION OF THE DRAWINGS

FIG. 1A is a block diagram of an example apparatus constructed in accordance with the teachings of the invention.

FIG. 1B is a block diagram of the database repository of FIG. 1A.

FIG. 2 is an example compiler options comparison table that may be used to compare the performance of compiler options configurations.

FIG. 3 is an example compiler options configurations ranking table that may be used to rank compiler options configurations based on measured performance characteristics.

FIG. 4 is a flowchart representative of machine readable instructions that may be executed to implement the example apparatus of FIG. 1A.

FIG. 5 is a flowchart representative of machine readable instructions that may be executed to implement the object code profiler of the example apparatus of FIG. 1A.

FIG. 6 is a flowchart representative of machine readable instructions that may be executed to implement the performance analyzer and the compiler options selector of the example apparatus of FIG. 1A.

FIG. 7 is a flowchart representative of machine readable instructions that may be executed to implement the performance analyzer and the table generator of the example apparatus of FIG. 1A.

FIG. 8 is another flowchart representative of machine readable instructions that may be executed to implement the performance analyzer and the table generator of the example apparatus of FIG. 1A.

FIG. 9 is a block diagram of an example processor system that may execute the machine readable instructions represented by FIGS. 4-7 and/or 8 to implement the apparatus of FIG. 1A.

### DETAILED DESCRIPTION

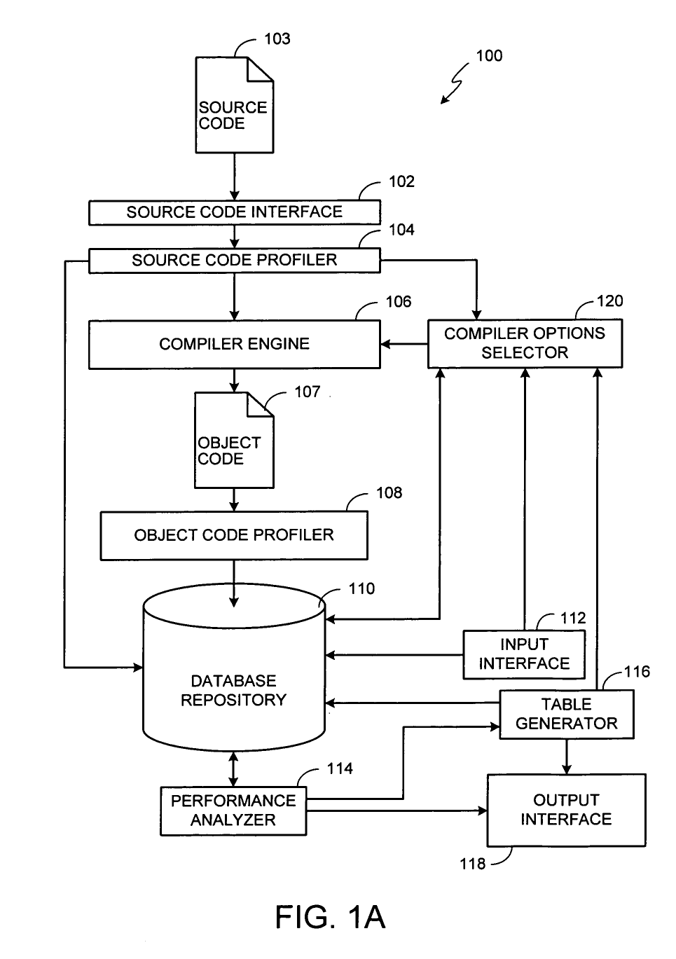

An example compiler 100 constructed in accordance with the teachings of the invention is shown in FIG. 1A. The example apparatus 100 and/or methods described herein may be used to optimize software and software compilation processes in an automated manner. For example, the illustrated apparatus 100 is configured to optimize software and software compilation processes by recompiling source code one or more times until the compiler 100 generates object code having acceptable performance characteristics. For each time that the compiler 100 compiles the source code, the compiler 100 automatically selects different compiler options based on user-defined performance characteristics, source code structural characteristics, object code structural characteristics, and empirical data correlating the compiler options to the performance characteristics and structural characteristics of the code being compiled. More specifically, the compiler 100 of the illustrated example obtains user-defined target performance characteristics or performance characteristic threshold or limit values once from a user, and automatically compiles the source code to generate object code having performance characteristic values that substantially meet or exceeded (e.g., are substantially equal to or better than) the target performance characteristic values or threshold values. Further, if after a plurality of compilations, the example compiler 100 cannot generate object code that satisfies the target or threshold values, the compiler 100 provides a user with comparisons of performance characteristics associated with the object code to enable the user to make informed decisions regarding performance tradeoffs that may enable the compiler 100 to generate object code having performance characteristics that are acceptable, or are relatively similar to, the target performance characteristic values or threshold values.

The example compiler 100 illustrated herein is structured to use an automated compiler options selection process to generate object code having performance characteristics that meet or exceed target performance characteristics specified by a user. The performance characteristics may be related to the compilation process (e.g., compilation duration) or the performance of the object code (e.g., binary size, execution time, stack size, heap size, etc.). Target performance characteristics may be specified, for example, according to system requirements or software development project requirements. System requirements may include, for example, memory capacity of a device (e.g., a personal digital assistant (PDA), a mobile phone, an embedded system, etc.), processing power, battery capacity, etc. Project requirements may include, for example, the time available to compile or build a project.

Particular system architectures of consumer devices (e.g., mobile phones, PDA's, etc.) may set forth various limitations on software. For example, to increase battery life of a portable device or to keep system costs low, a system architecture may have a limited amount of memory, which may constrain some software to a minimal amount of memory usage (e.g., a limited stack size). In this case, a programmer may specify a target performance memory characteristic based on the amount of memory available in the system architecture. The example compiler 100 illustrated herein may be configured to repeatedly compile the source code until it generates object code having a code size that is substantially equal to or less than the available amount of memory. Each time that the resulting object code is unacceptable or not substantially less than or equal to the specified amount of memory, the compiler 100 may automatically select new compiler options to further decrease the code size and recompile the source code based on the new compiler options. In this manner, the illustrated compiler 100 may recompile the source code a plurality of times based on a corresponding plurality of compiler options configurations to generate a plurality of object code until one of the plurality of object code has acceptable performance characteristics, or until a timeout event (e.g., completion of a predetermined number of recompilations) occurs.

Often software development projects have time constraints that define the amount of time available to build or compile the project. For example, some software development projects employ a daily build and test process. Development groups sometimes build and test their project overnight, which limits the amount of time available for compiling the project. In this case, a programmer may specify a target compilation time/duration performance characteristic so that the example compiler 100 illustrated in FIG. 1A may determine a compiler options configuration that will compile the project within the allowed time. In this case, the compiler 100 may perform several compilations based on a plurality of compiler options configurations and select the configuration that enables the fastest compilation time. The compiler 100 may then store the compiling options configuration in a file or database (e.g., a project configuration database 111d shown in FIG. 1B) for subsequent retrieval to complete subsequent compilations within the available time.

The example compiler 100 of described herein may obtain source code and user-defined performance characteristic values or target performance characteristic values from a user. The compiler 100 may compile the source code to generate object code and then profile the object code to determine measured performance characteristic values associated with the object code. The compiler 100 may then compare the measured performance characteristic values to the target performance characteristic values. If the measured performance characteristic values are unacceptable or not substantially similar to, equal to, or better than the target performance characteristic values, the compiler 100 may select one of a plurality of compiler options configurations based on empirical data correlating the compiler options configurations to the performance characteristics and structural characteristics of the source code and/or the object code. The compiler 100 may then recompile the source code based on the selected compiler options configuration to generate new object code. In this manner, the compiler 100 may iteratively compile the source code, compare measured and target performance characteristic values, and select a subsequent compiler options configuration for each subsequent compilation without obtaining further user input until the measured characteristic values substantially meet or exceed the target performance characteristic values, until the compiler has compiled the source code a particular number of times, or until the compiler has exhausted all compiler options configurations.

The target performance characteristics may be absolute performance characteristic values (e.g., an absolute code size, an absolute execution time, an absolute compilation time, etc.) or relative performance characteristic values that are based on the performance characteristics of a baseline object code. The compiler 100 may generate baseline object code by compiling source code using a baseline compiler options configuration. The user may then specify relative performance characteristic values in terms of a percentage of baseline performance characteristics associated with the baseline object code.

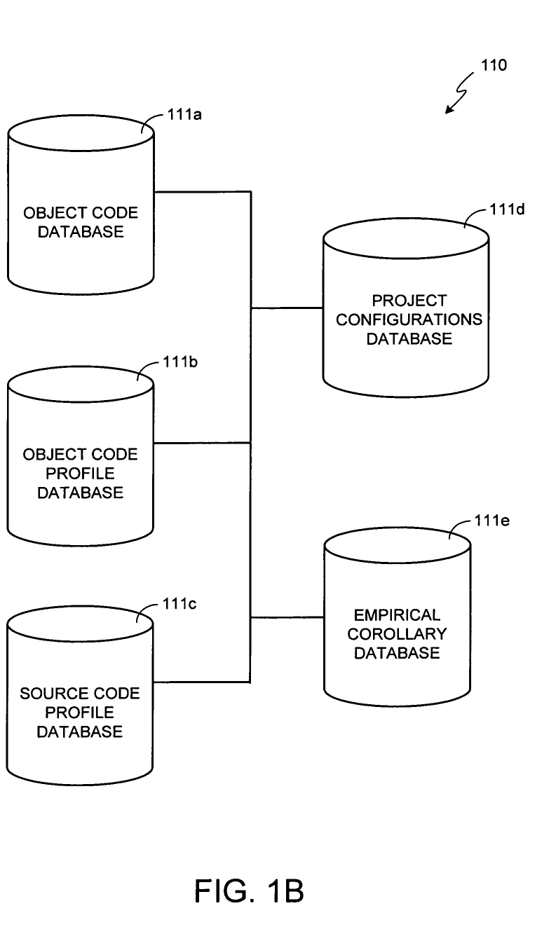

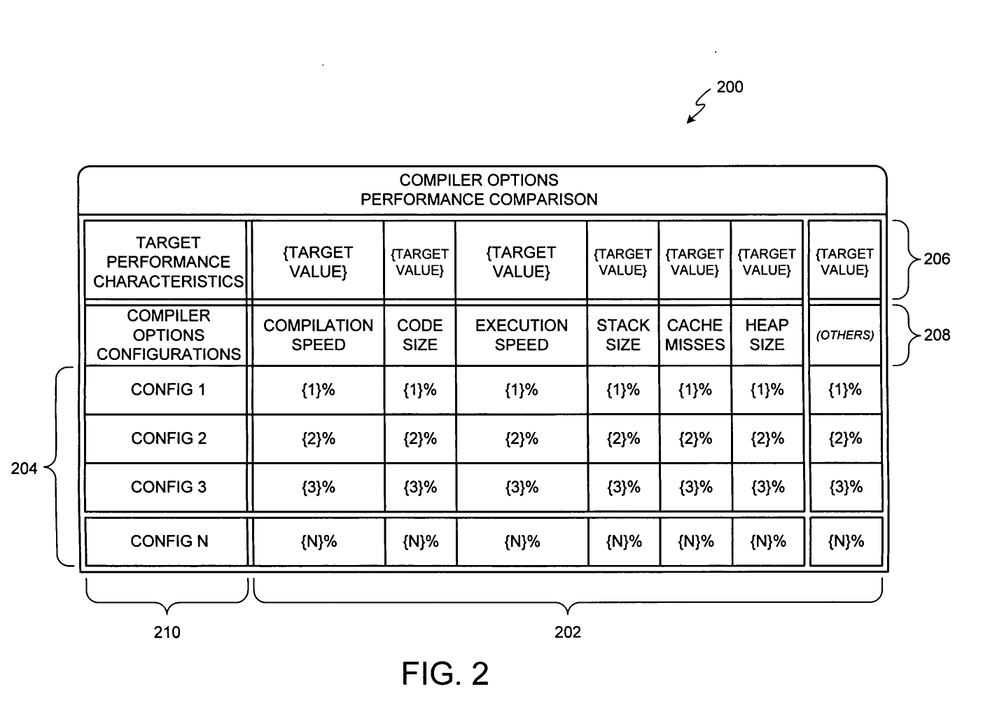

If the compiler 100 does not generate object code having acceptable performance characteristics after the compiler has recompiled the source code a predetermined number of times or after the compiler has exhausted all possible compiler options configurations, the compiler generates one or more tables showing the performance results associated with each object code that was generated based on each of the selected compiler options configurations. For example, the tables may include the example compiler options performance comparison table and/or the example compiler options configurations ranking table described below in connection with FIGS. 2 and 3. The example compiler options performance comparison table of FIG. 2 is used to compare the performance characteristic values of all the compiler options configurations. The example compiler options configurations ranking table of FIG. 3 may be used to rank the plurality of compiler options configurations based on ratios of two performance characteristics (e.g., execution time and object code size).

A user may use the comparison and ranking information provided in the tables to make decisions regarding performance trade-offs or different threshold values that will enable the compiler 100 to generate object code having acceptable performance characteristics (e.g., measured performance characteristics that are relatively similar to the target performance values or within threshold limits of the target performance values). For example, a user may analyze the comparison and/or ranking tables of FIGS. 2 and 3, and select a compiler options configuration that generates object code having a ten percent increase in code size over the target code size, but has an execution time that meets or exceeds the target execution time.

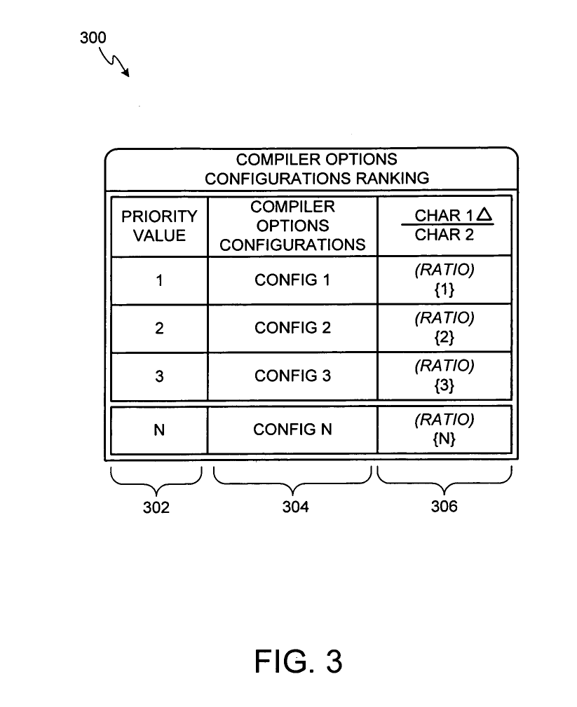

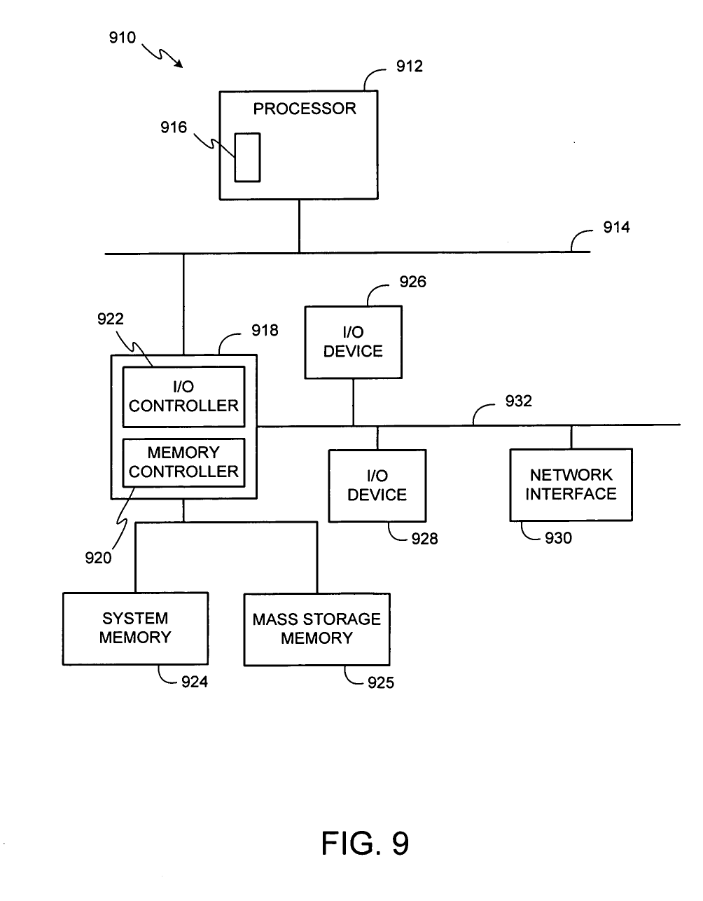

The example compiler 100 shown in FIG. 1A may be implemented using any desired combination of hardware and/or software. For example, one or more integrated circuits, discrete semiconductor components, or passive electronic components may be used. Additionally or alternatively, some or all, or parts thereof, of the blocks of the example apparatus 100 may be implemented using instructions, code, or other software and/or firmware, etc. stored on a machine accessible medium that, when executed by, for example, a processor system (e.g., the example processor system 910 of FIG. 9), perform the operations represented in the flow diagrams of FIGS. 4-8.

For the purpose of obtaining source code, the example apparatus 100 is provided with a source code interface 102. In the illustrated example, the source code interface 102 is configured to obtain source code 103 from a memory (e.g., the system memory 924 or mass storage memory 925 of FIG. 9). For example, the source code 103 may be a source code file, a source code module, etc. that is specified by a user. The source code interface 102 communicates the source code 103 to a source code profiler 104 (described below). In some implementations, the source code interface 102 is configured to systematically or sequentially obtain a plurality of source code modules or files associated with a large project. For example, when the illustrated apparatus 100 is configured to compile or build a large project, the source code interface 102 may obtain a next source code module or file after the example apparatus 100 has finished compiling a current source code module or file.

For the purpose of characterizing source code, the example apparatus 100 is provided with the source code profiler 104. In the illustrated example, the source code profiler 104 is configured to characterize the source code 103 obtained from the source code interface 102 to generate a source code profile for the source code 103. For example, the source code profiler 104 may analyze the source code 103 and determine the types of structural characteristics associated with the source code 103. Structural characteristics may include the number of functions in the source code 103, the number of function calls, the types of function calls (e.g., call by reference, call by value, etc.), types of variables initialized (e.g., global variables, local variables, volatile variables, etc.), types of pointers, number of pointers, type castings, re-entrant/non-reentrant functions, number of and types of data structures, etc. After characterizing the source code 103, the source code profiler 104 communicates the source code profile to a database repository 110 (described below). The source code profiler 104 also communicates the source code 103 to a compiler engine 106 (described below) and communicates an interrupt or message to a compiler options selector 120 (described below) informing the compiler selector 120 that new source code has been obtained and is ready to be compiled.

In the illustrated example, the compiler engine 106 is configured to generate object code 107 by compiling the source code 103 based on compiler options configurations obtained from the compiler options selector 120. The compiler engine 106 is configured to compile a particular source code one or more times until the resulting object code and/or the compilation process have characteristics that are substantially similar to, equal to, or better than target performance characteristics. The compiler engine 106 may first compile the source code 103 based on an initial compiler options configuration and subsequently recompile the source code 103 based on one or more other compiler options configuration(s) selected by the compiler options selector 120.

The compiler engine 106 is configured to optimize the object code 107 and/or the compiling process based on the provided compiler options configurations. For example, if the compiler options configuration has a loop unrolling optimization option, the compiler engine 106 may unroll loop functions in the source code during the compiling process. Additionally, the time spent during the compiling process (i.e., the compilation time) may be controlled based on the types of optimization options provided to the compiler engine 106. For example, if a target compilation time is relatively short and the source code profile for the source code 103 indicates a large number of loop functions, a compiler options configuration may not include a loop unrolling optimization option, thus causing the compiler engine 106 to reduce the compilation time by not having to optimize a large quantity of loops.

For the purpose of characterizing object code, the example apparatus 100 is provided with the object code profiler 108. In the illustrated example, the object code profiler 108 is configured to generate object code profiles for the object code 107 obtained from the compiler engine 106 by determining structural characteristics and measured performance characteristics of the object code 107. For example, the object code profiler 108 may determine binary sizes and instruction-related characteristics of the object code 107. Instruction-related characteristics may include the types of and number of instructions in the object code 107 such as, for example, the number of jumps, conditional branches, write operations, read operations, etc.

The object code profiler 108 may also determine execution-related characteristics. For instance, in the illustrated example, the object code profiler 108 includes an execution engine configured to execute the object code 107 while the object code profiler 108 measures the execution speed and other execution-related performance characteristics of the object code 107. Example execution-related characteristics include execution time (e.g., the time required for a complete run of the object code), dynamic code size (e.g., the size of the working set associated with the object code, number of pages of virtual memory needed to store the working set, etc.), power consumption (e.g., the power consumption of the processor to run the object code), thread usage (e.g., the number of parallel threads that are used to execute the object code), architectural system criteria (e.g., number of registers used during execution), micro-architectural events (e.g., cache hits/misses, branches taken, etc.), etc. Of course, these are merely some examples of execution-related characteristics. The object code profiler 108 may be configured to measure any other execution-related characteristics.

Further, the object code profiler 108 may be configured to measure performance characteristics associated with the compilation process. For example, the object code profiler 108 may measure or determine a compilation time characteristic corresponding to the amount of time required by the compiler engine 106 to generate the object code 107. For example, the compiler engine 106 may issue interrupts or messages to the object code profiler 108 informing the object code profiler 108 when the compiler engine 106 starts and ends a compiling process. Alternatively or additionally, the compiler engine 106 may generate a start compile timestamp and an end compile timestamp, or a total compile time value in a header of the object code 107. In either case, the object code profiler 108 may use compile time information to add a compiling time value to the object code profile of the object code 107. The object code profiler 108 stores the measured performance characteristics and structural characteristics in the object code profile for the object code 107. The object code profile is stored in the database repository 110.

For the purpose of storing source and object code profiles, compiler options, historical compilation data and other compiler-related information, the example apparatus 100 is provided with the database repository 110. The database repository 110 may comprise one or more databases or data structures and may be implemented using a memory such as, for example, the mass storage memory 925 (FIG. 9). Each database stored in the database repository 110 may be stored as a separate file. As shown in FIG. 1B, the database repository 110 may include an object code database or data structure 111a (e.g., for storing the object code 107), an object code profile database 111b (e.g., for storing the object code profile), a source code profile database 111c (e.g., for storing the source code profiles generated by the source code profiler 104), a project configurations database 111d (e.g., for storing compiler options configurations associated with particular software development projects), and an empirical corollary database 111e (described below). Of course the database repository 110 may include any other databases.

The empirical corollary database 111e may include a plurality of compiler options, source and object code structural characteristics, and measured performance characteristic values. The information in the empirical corollary database 111e may be collected over time from various compilation processes and may include ranking information associated with compiler options, compiler options configurations, and performance characteristics associated therewith. The empirical corollary database 111e may be used by the example apparatus 100 to select compiler options configurations by comparing the structural characteristics of source code (e.g., the source code 103) generated by the source code profiler 104 and object code (e.g., the object code 107) generated by the object code profiler 108 to structural characteristics stored in the empirical corollary database 111e to determine a compiler options configuration that can be used to generate object code having performance characteristics that meet or exceed the target performance characteristics.

Further, the database repository 110 may be used to store project configuration databases or files. Project configuration databases may be used for long-term software development projects and may be used to store compiler options configurations that may be used by the compiler engine 106 to compile object code within compiler-process-related performance characteristics (e.g., compilation time). In this manner, during a software development project, when a development team builds a project, the example apparatus 100 can ensure that the compilation process is performed according to the compilation process performance characteristics specified by the development teams. As the development team changes source code files or modules during the development cycle, the example apparatus 100 may update the project configuration database when necessary by selecting new compiler options configurations to ensure that project builds meet specified target performance characteristics for the compilation process.

For the purpose of obtaining user input or feedback, the example apparatus 100 is provided with an input interface 112. In the illustrated example, the input interface 112 is used to enter target performance characteristics, select a compiler options configuration, and provide the example apparatus 100 with other compiler-related input. Target performance characteristics entered via the input interface 112 may be communicated to, and stored in, the database repository 110 in, for example, a target performance characteristics database. A compiler options configuration selected via the input interface 112 may be communicated to the compiler options selector 120. The input interface 112 may be implemented using a keyboard, a touchscreen, and/or any other suitable user input device(s).

In order to analyze performance of the compilation process and the resulting object code, the example apparatus 100 is provided with a performance analyzer 114. For example, the performance analyzer 114 obtains measured performance characteristics of the object code 107 (e.g., code size, execution time, etc.) and the compilation process (e.g., compilation time) and target performance characteristic values from the database repository 110, and determines whether measured performance characteristic values are substantially similar to, equal to, or better than the target performance characteristic values by comparing the measured performance characteristic values to the target performance characteristic values. If the performance analyzer 114 determines that the object code 107 has performance characteristics (e.g., the measured performance characteristics) that satisfy the target performance characteristics, then the performance analyzer 114 may output via an output interface 118 described below, the compiler options configuration that the compiler engine 106 used to generate the object code having acceptable performance characteristics. If the performance analyzer 114 determines that a most recent object code does not have performance characteristics that satisfy the target performance characteristics, the performance analyzer 114 may store a message or flag in the database repository 110 indicating that the last compilation process did not produce acceptable object code.

In the illustrated example, the performance analyzer 114 also generates percentage improvements or differences based on the measured and/or target performance characteristics as described below in connection with FIGS. 2 and 3. The performance analyzer 114 may be configured to perform any mathematical functions such as statistical functions, percentage functions, basic mathematical functions, etc. suitable for analyzing the performance characteristics. In particular, in the illustrated example, the performance analyzer 114 is configured to implement the mathematical functions described below in connection with Equations 3-5. Further, the performance analyzer 114 may generate priority or ranking values as described below in connection with FIG. 3 to compare performance characteristics associated with compiler options configurations. The performance analyzer 114 may communicate analysis values such as, for example, percentage improvements, measured performance characteristics, priority/ranking values, etc. to a table generator 116, which may then generate tables for display to a user or for use in subsequent compilations.

For the purpose of generating tables, the example apparatus 100 may be provided with the table generator 116. The table generator 116 of the illustrated example is configured to generate tables associated with object code performance and compilation process performance based on target performance characteristic values and measured performance characteristic values. For example, the table generator 116 may generate compiler options performance comparison tables (e.g., the example compiler options performance comparison table 200 of FIG. 2) and compiler options configurations ranking tables (e.g., the example compiler options configurations ranking table 300 of FIG. 3) based on target and measured performance characteristic values and compiler options configurations obtained from the database repository 110. The table generator 116 may be configured to perform any mathematical functions suitable for generating tables of interest.

In the illustrated example, the table generator 116 is also configured to store the tables in the database repository 110 in one or more table databases. The table generator 116 may be configured to communicate the tables to the output interface 118 (directly or via the database repository 110) to enable the output interface 118 to display the tables to a user. The table generator 116 may communicate the compiler options configurations used to generate each table to the compiler options selector 120. In this manner, when a user selects a compiler options configuration via the input interface 112, the compiler options selector 120 may communicate the selected configuration to the compiler engine 106.

To output compiler-related information to a user, the example apparatus 100 is provided with the output interface 118. In the illustrated example, the output interface 118 is configured to display to a user compiler options related tables obtained from the table generator 116. The output interface 118 may be implemented using a computer display such as, for example, a cathode ray tube (CRT), a liquid crystal display (LCD), a plasma display, etc. Alternatively, or additionally, the output interface 118 may be implemented using a printer configured to print the tables obtained from the table generator 116 or any other information of interest to a programmer.

In order to automatically select compiler options and generate compiler options configurations, the example apparatus 100 is provided with the compiler options selector 120. In the illustrated example, the compiler options selector 120 is configured to obtain compiler options from the table generator 116 and/or the database repository 110 and to obtain from the performance analyzer 114 performance analyses results such as, for example, performance differences or improvements described below in connection with FIGS. 2 and 3 and Equations 3-5. The compiler options selector 120 may automatically select and/or generate compiler options configurations based on the performance analyses results, source code profiles, object code profiles, and empirical data that correlates compiler optimization options to the performance characteristics and/or the structural characteristics of source code and/or object code. In this manner, the compiler options selector 120 may select one or more compiler optimization options such as, for example, loop optimization, interprocedural optimization, address optimization, block merging, branch elimination, dead code elimination, function inlining, loop collapsing, and/or loop unrolling. Of course any other compiler options may be used in the example apparatus 100.

The compiler options selector 120 may select and/or generate compiler options configurations in response to interrupts, messages, or other communications from other portions of the example apparatus 100. For example, after the source code profiler 104 characterizes new source code, the source code profiler 104 is configured to communicate an interrupt to the compiler options selector 120. The compiler options selector 120 is configured to respond by communicating an initial compiler options configuration to the compiler engine 106. The initial compiler options configuration may be a general or baseline set of options that is, for example, relatively conservative, and typically used for the initial compilation of newly obtained source code. The baseline compiler options configuration causes the compiler engine 106 to generate object code having a baseline optimization (which may be substantially non-optimized). The example apparatus 100 may analyze the generated object code (via the object code profiler 108, the comparison table generator 112, the performance analyzer 114, and the compiler options selector 120) to gauge or empirically determine the effects that the structural characteristics of the source code 103 have on the compilation process and resulting object code. The compiler options selector 120 may select subsequent compiler options configurations to optimize the object code 107 or the compilation process based on the object code analysis and target performance characteristics.

The compiler options selector 120 is also configured to obtain compiler options and/or compiler options-related input from the input interface 112 (e.g., directly or via the database repository 110). In this manner, if a user selects a compiler options configuration via the input interface 112, the compiler options selector 120 may obtain the compiler options configuration from the table generator 116 or the database repository 110 and communicate the configuration to the compiler engine 106. The compiler options selector 120 is also configured to select compiler options from the database repository 110 based on user feedback such as, for example, performance trade-offs or updated target performance characteristic values.

FIG. 2 is an example compiler options comparison table 200 that may be used to compare the performance of compiler options configurations. More specifically, the compiler options comparison table 200 may be used to compare the compiler options configurations generated by, for example, the compiler options selector 120 (FIG. 1A) based on the target performance characteristic values provided by a user via, for example, the input interface 112 (FIG. 1A) and/or measured performance characteristic values generated by, for example, the object code profiler 108 (FIG. 1A). The compiler options configurations may be compared based on performance evaluation values associated with the measured performance characteristic values and the target performance characteristic values for any performance characteristic type (e.g., compilation speed, code size, execution speed, etc.) specified by a user. The performance evaluation values may be expressed in terms of a performance difference (e.g., percentage improvements) and/or in terms of an error percentage between a target and measured performance characteristic value as described below in connection with Equations 3 and 4.

The table generator 116 (FIG. 1A) may generate the compiler options performance comparison table 200 after the example apparatus 100 has compiled the source code 103 (FIG. 1A) a predetermined number of times without achieving object code 107 having measured performance characteristic values that are substantially similar to, equal to, or better than the target performance characteristic values. The compiler options performance comparison table 200 may be displayed to a user via the output interface 118 to enable the user to select a particular compiler options configuration based on the user's threshold or tolerance associated with one or more performance characteristics. For example, based on the comparison table 200 a user may decide that a particular generated object code has measured performance characteristic values that are acceptable even though they are not substantially similar to, equal to, or better than the user's target performance characteristics specified prior to starting the compiling process.

The comparison table 200 may also enable a user to change one or more of the target performance characteristic values to trade off performance of one characteristic (e.g., execution speed) for a better performance of another characteristic (e.g., code size). The user may provide input to the example apparatus 100 via the input interface 112 and configure the example apparatus 100 to perform a subsequent set of compiling processes based on a selected compiler options configuration or to determine another set of compiler options configurations to achieve updated target performance characteristic values and generate a subsequent compiler options comparison table if the updated target performance characteristic values are not achieved after performing a predetermined number of compilations.

Turning in detail to FIG. 2, the example compiler options comparison table 200 includes a plurality of columns 202 associated with performance characteristic types and a plurality of rows 204 associated with a plurality of compiler options configurations. The target performance characteristic values are provided in a target performance row 206, the name of each characteristic type is provided in a characteristic type row 208, and the performance evaluation values are provided in the corresponding cells for the corresponding characteristic types and compiler options configurations. Each compiler options configuration is listed in a compiler options column 210 for each one of the plurality of rows 204.

The target performance characteristic values provided in the target performance row 206 may be absolute performance characteristic values or relative performance characteristic values. Absolute performance characteristic values define actual measured performance characteristics. For example, an absolute memory constraint may be specified in terms of the desired object code binary size. In this case, the binary size of object code should be substantially equal to or less than the specified absolute memory constraint. A relative performance characteristic value is based on measured performance characteristic values of a baseline object code. For example, the compiler engine 106 may generate baseline object code (e.g., the object code 107 of FIG. 1A) by compiling source code (e.g., the source code 103 of FIG. 1A) using a baseline compiler options configuration. The user may then specify relative performance characteristic values in terms of a percentage of the measured performance characteristics of the baseline object code. In this manner, a user may specify that the execution speed of object code should be ten percent faster than the execution speed of the baseline object code. A relative performance characteristic may be interpreted by the compiler engine 106 according to Equations 1 and 2 below.

$$\begin{matrix}R ( \% ) = \frac{B - T}{T} \cdot 100 & Equation 1 \\ T = B \cdot ( 1 + \frac{R}{100} ) & Equation 2\end{matrix}$$

As shown above in Equation 1, a relative performance characteristic (R) specified as a percentage may be expressed in terms of a baseline performance characteristic value (B) and a target performance characteristic value (T). More specifically, in Equation 1, the target performance characteristic value T is subtracted from the baseline performance characteristic value B to generate a difference value (B−T). The difference value (B−T) is divided by the target performance characteristic value T to generate a quotient value

$$( \frac{B - T}{T} )$$

that is then multiplied by one hundred to determine the relative performance characteristic R.

As shown above in Equation 2, the performance analyzer 114 (FIG. 1A) may determine the target performance characteristic value T during a compilation process based on the relative performance characteristic value R. More specifically, the example apparatus 100 may divide the relative performance characteristic R by one hundred to generate a quotient value

$$( \frac{R}{100} ) ,$$

add the quotient value to one to generate a sum value

$$( 1 + \frac{R}{100} ) ,$$

and multiply the sum value

$$( 1 + \frac{R}{100} )$$

by the baseline performance characteristic value B.

The performance evaluation values provided in the plurality of columns 202 for each performance characteristic may be determined according to the percentage function shown in Equation 3 below or the error function shown in Equation 4 below.

$$\begin{matrix}P ( \% ) = \frac{M}{T} \cdot 100 & Equation 3 \\ E ( \% ) = \frac{M - T}{T} \cdot 100 & Equation 4\end{matrix}$$

As shown in Equation 3 above, the percentage function may be used to determine a percentage difference value P between a measured performance characteristic value (M) and the target performance characteristic value T. In particular, the performance analyzer 114 described above in connection with FIG. 1A may determine the percentage difference value P by dividing the measured performance characteristic value M by the target performance characteristic value T and multiplying the result by 100. The performance analyzer 114 may also determine an error percentage value according to Equation 4 above by subtracting the target performance characteristic value T from the measured characteristic value M, dividing the result by the target performance characteristic value T to generate a quotient value

$$( \frac{M - T}{T} ) ,$$

and multiplying the quotient value

$$( \frac{M - T}{T} )$$

by 100.

FIG. 3 is an example compiler options configurations ranking table 300 that may be used to rank compiler options configurations based on measured performance characteristics. The performance characteristics may be first and second performance characteristics that are specified by a user. The compiler options configurations ranked in the ranking table 300 are selected by, for example, the compiler options selector 120 (FIG. 1A) during one or more compilations of source code (e.g., the source code 103 of FIG. 1A). The table generator 116 (FIG. 1A) may rank compiler options configurations based on a performance improvement (i.e., a performance change or delta) of the measured performance characteristics (e.g., execution speed, object code size, etc.) to enable a user to determine the tradeoffs associated with each compiler options configuration in terms of a first performance characteristic and a second performance characteristic.

As shown in FIG. 3, the ranking table 300 includes a priority value column 302, a compiler options configurations column 304, and a ratio column 306. The priority value column 302 includes priority or ranking values that designate the rank of each of the compiler configurations. The compiler options configuration column 304 specifies the compiler options selected for each compiler options configuration. The ratio column 306 specifies ratios that are generated based on first and second measured performance characteristics for the object code generated using the compiler options configurations in the compiler options configurations column 304. The ratios may be determined by the performance analyzer 114 described above in connection with FIG. 1A according to Equation 5 below.

$$Ratio = \frac{Δ {C}_{1}}{{C}_{2}} , where Δ {C}_{1} = {BC}_{1} - {MC}_{1} \qquad Equation 5$$

The performance analyzer 114 may determine a ratio according to Equation 5 above by dividing a performance improvement of a first measured performance characteristic value ΔC₁ by a second measured characteristic value C₂. The performance improvement of the first performance characteristic value ΔC₁ is determined by subtracting a measured performance characteristic value MC₁ from a baseline performance characteristic value BC₁.

The baseline performance characteristic value is associated with a baseline object code compiled by the compiler based on a baseline compiler options configuration. Each of the compiler options configurations ranked in the ranking table 300 are ranked based on an improvement or performance difference between the object code of the corresponding compiler options configurations and the baseline object code. In this manner, if the first performance characteristic C₁ is execution speed and the second performance characteristic C₂ is code size, when two different compilations produce first and second object code having the same executions speed improvement ΔC₁, the object code having the smaller code size C₂ gets a higher rank. Further, when two optimizations resulting in first and second object code having the same code size C₂, the object code having a higher performance improvement ΔC₁ is ranked higher.

Flowcharts representative of example machine readable instructions for implementing the example apparatus 100 of FIG. 1A are shown in FIGS. 4 through 8. In these examples, the machine readable instructions comprise a program for execution by a processor such as the processor 912 shown in the example processor system 910 of FIG. 9. The program may be embodied in software stored on a tangible medium such as a CD-ROM, a floppy disk, a hard drive, a digital versatile disk (DVD), or a memory associated with the processor 912 and/or embodied in firmware or dedicated hardware in a well-known manner. For example, any or all of the source code interface 102, the source code characterizer 104, the compiler engine 106, the object code characterizer 108, the input interface 112, the performance analyzer 114, the table generator 116, the output interface 118, and/or the compiler options selector 120 could be implemented by software, hardware, and/or firmware. Further, although the example program is described with reference to the flowcharts illustrated in FIGS. 4-8, persons of ordinary skill in the art will readily appreciate that many other methods of implementing the example apparatus 100 may alternatively be used. For example the order of execution of the blocks may be changed, and/or some of the blocks described may be changed, eliminated, or combined.

The program begins at FIG. 4 by initially obtaining source code (e.g., the source code 103 of FIG. 1A) (block 402) via the source code interface 102 described above in connection with FIG. 1A. The example apparatus 100 then obtains target performance characteristic values (block 404) from a user via the input interface 112 (FIG. 1A). The target performance characteristic values may be absolute performance characteristic values or relative performance characteristic values as described above.

The source code profiler 104 (FIG. 1A) then determines structural characteristics of the source code 103 and stores the source code structural characteristics (block 406) in the database repository 110 (FIG. 1A). The compiler engine 106 (FIG. 1A) then obtains a first compiler options configuration (block 408). Specifically, the compiler engine 106 obtains the first compiler options configuration from the compiler options selector 120 (FIG. 1A). The first compiler options configuration may be a general baseline compiler options configuration that the compiler options selector 120 is configured to provide each time a new source code is obtained. Alternatively, the first compiler options configuration may be generated by the compiler options selector 120 based on the source code structural characteristics generated by the source code profiler 104.

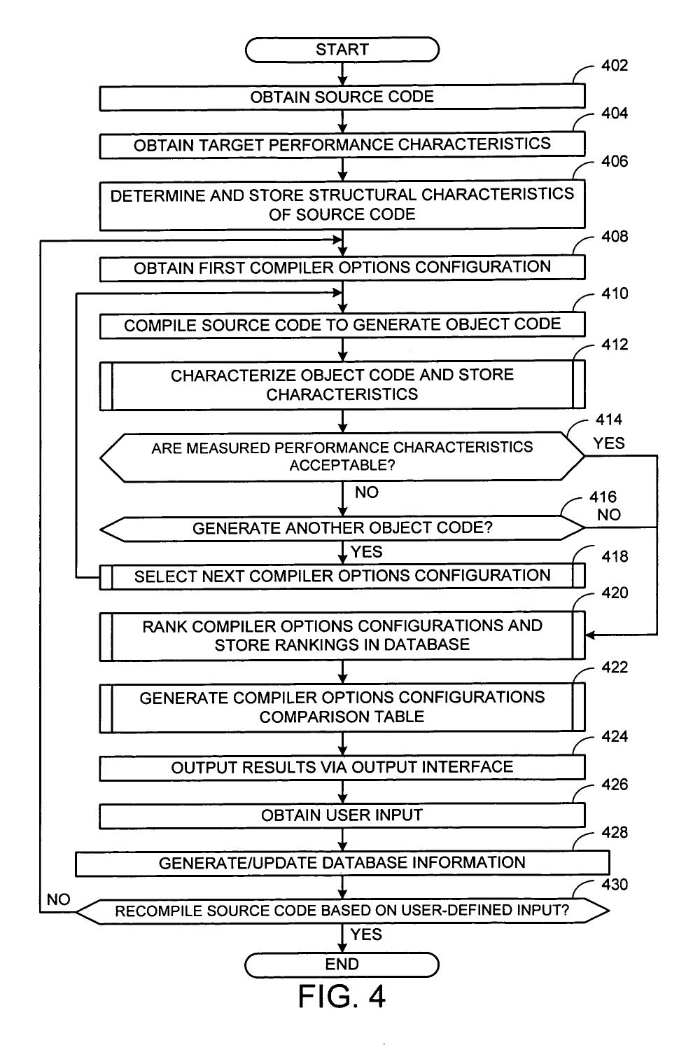

The compiler engine 106 then compiles the source code 103 to generate object code (e.g., the object code 107 of FIG. 1A) (block 410). In particular, the compiler engine 106 compiles the source code 103 based on the first compiler options configuration obtained at block 408 or based on compiler options configurations selected during subsequent compilations as described below in connection with block 418. The object code profiler 108 (FIG. 1A) then characterizes the object code 107 generated at block 412 to determine performance characteristics and structural characteristics of the object code 107 and stores the characteristics in, for example, the database repository 110 (FIG. 1A) (block 412). The operation of block 412 may be implemented as described below in connection with the flowchart of FIG. 5.

The performance analyzer 114 (FIG. 1A) then determines if the measured performance characteristic values generated at block 412 are acceptable (block 414). In the illustrated example, the performance analyzer 114 compares the measured performance characteristic values of the object code 107 to the target performance characteristic values obtained at block 404 to see if they are substantially similar or equal to one another or if the measured performance characteristic values are better than the target performance characteristic values.

If the example apparatus 100 determines that the measured performance characteristic values are not acceptable (i.e., do not satisfy the target performance characteristic values), then the example apparatus 100 determines whether it should recompile to generate different object code (e.g., perform another compilation of the source code 103) (block 416). For example, the example apparatus 100 may determine if it has exhausted all possible compiler options configurations or if it has generated a sufficient number of object code results (e.g., has performed a predetermined number of compilations). In particular, a user may configure the example apparatus 100 to generate a predetermined number of object code results before providing performance analysis results to a user. In this case, if the example apparatus 100 generates the predetermined number of object code results before generating object code having acceptable performance characteristics (block 416), then control advances to block 420 and the example apparatus 100 does not perform further compilations of the source code 103.

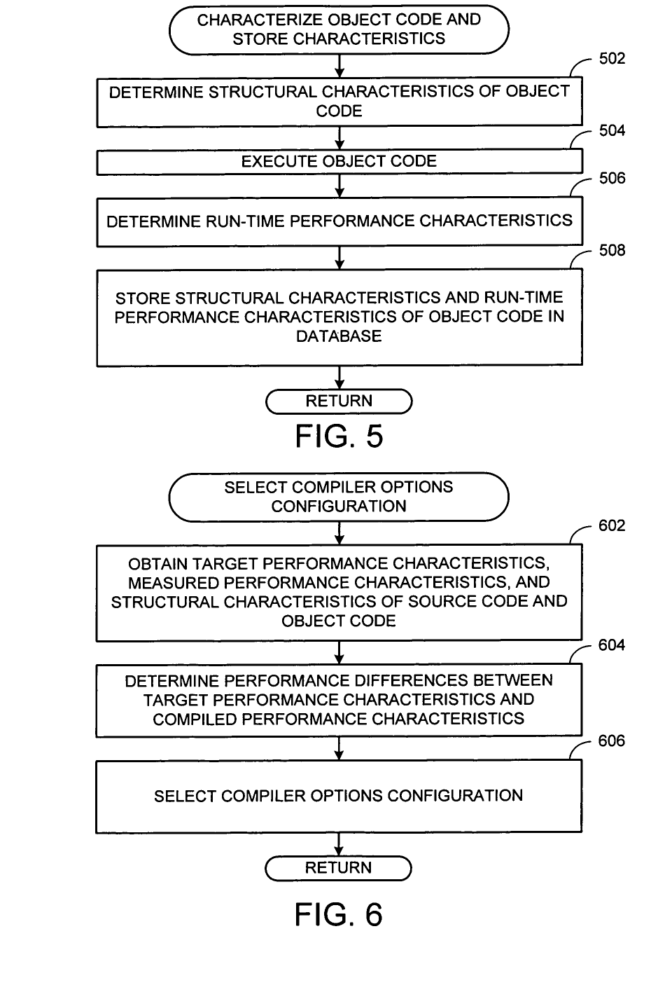

If, on the other hand, the example apparatus 100 determines that it should generate another object code 107 (block 416), then the compiler options selector 120 selects a next compiler options configuration (block 418) and control is passed back to block 410. The compiler options selector 120 determines a next compiler options configuration based on measured performance characteristics of the object code 107, target performance characteristics, source and object code structural characteristics, and empirical data correlating the compiler options configurations to the performance characteristics and the structural characteristics of the source code and object code. The operation of block 418 may be implemented as described below in connection with the flowchart of FIG. 6. The operations of blocks 410, 412, 416, and 418 may be repeated until the example apparatus 100 generates object code having acceptable performance characteristics, until the example apparatus 100 has exhausted all possible compiler options configuration, or until the example apparatus 100 has generated a predetermined number of object code results for a particular source code. In this manner, the example apparatus 100 may select or generate a plurality of compiler options configurations via the compiler options selector 120 that may later be ranked, compared, or otherwise tabulated for display to a user as described above in connection with FIGS. 2 and 3.

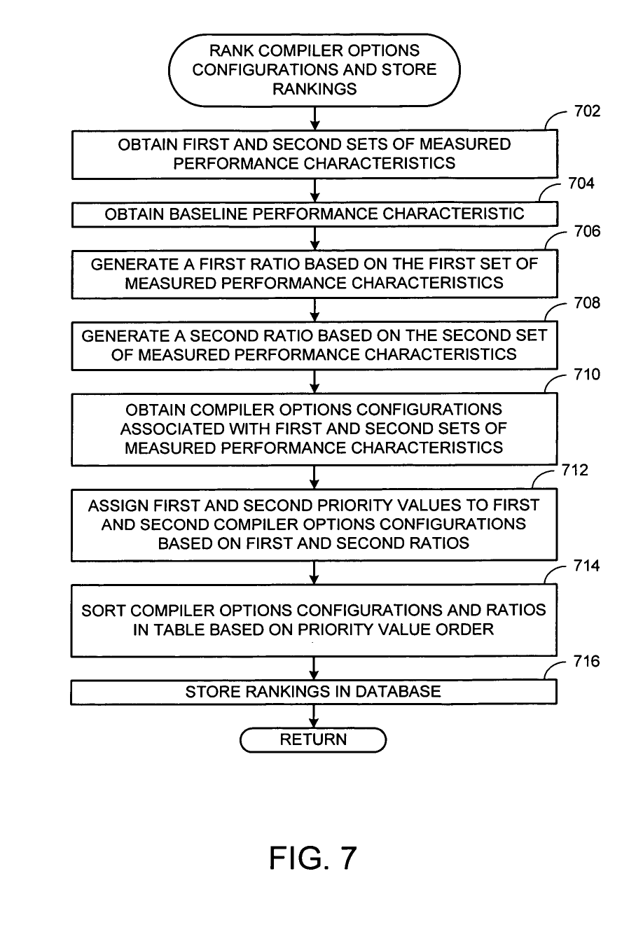

If the example apparatus 100 determines at block 414 that the measured performance characteristics of the object code 107 are acceptable (i.e., satisfy the target performance characteristics), or if the example apparatus 100 determines at block 416 that it should not generate another object code result, the performance analyzer 114 and the table generator 116 rank the compiler options configurations and store the rankings in the database repository 110 (block 420). For example, the performance analyzer 114 and the table generator 116 of FIG. 1A work cooperatively to generate a ranking table (e.g., the example compiler options configurations ranking table 300 of FIG. 3) based on the compiler options configurations selected at blocks 408 and 418. The operation of block 420 may be implemented using the example flowchart described below in connection with FIG. 7.

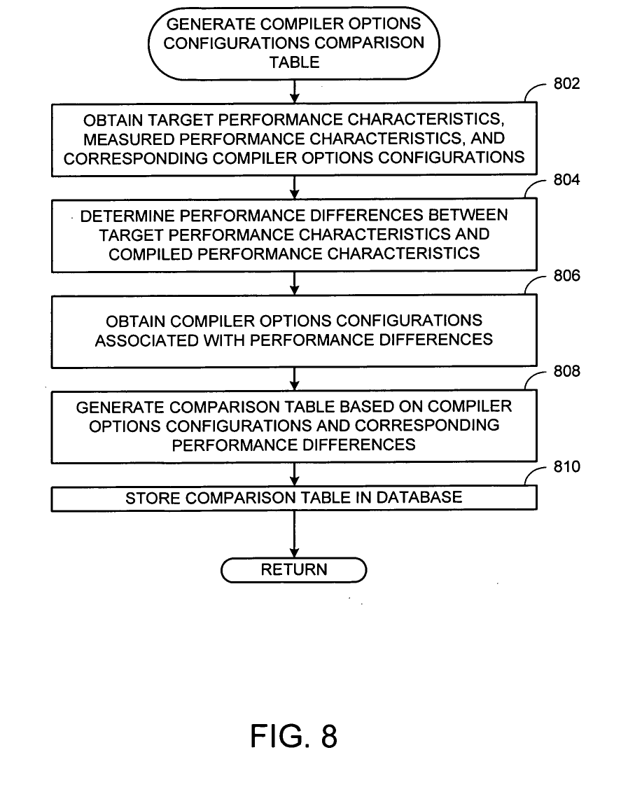

The performance analyzer 114 and the table generator 116 then generate a compiler options configurations comparison table (e.g., the compiler options performance comparison table 200 of FIG. 2) (block 422). In the illustrated example, the performance analyzer 114 and the table generator 116 generate the compiler options performance comparison table 200 based on the measured performance characteristics generated at block 412 and each compiler options configuration selected at blocks 408 and 418. The operation of block 422 may be implemented as described below in connection with the flowchart of FIG. 8.

The output interface 118 (FIG. 1A) then outputs compilation results (block 424). For instance, the output interface 118 outputs the comparison table 200 or the ranking table 300. Alternatively, if the example apparatus 100 has generated object code having acceptable measured performance characteristics, the example apparatus 100 outputs a message indicating that an acceptable object code file has been generated and outputs the specifics (e.g., storage location, measured performance characteristics, compiler options configuration, etc.) of the object code file.

After a user analyzes the displayed results, the user may provide feedback or user input via the input interface 112 (FIG. 1A) (block 426). For example, the user may provide updated target performance characteristic values in which the user trades off performance in one characteristic for increased performance in another characteristic. Alternatively or additionally, the user may provide performance threshold values for each specified performance characteristic. During subsequent compilations, the compiler options selector 120 may use the threshold values to select other compiler options configurations that generate object code having performance characteristics that are within the specified performance threshold values.

The example apparatus 100 then generates and/or updates information in the database repository 110 (FIG. 1A) (block 428). For example, if the user input includes new target performance characteristic values, the example apparatus 100 may overwrite the previously stored performance characteristic values with the new ones. If the user input includes threshold values, the example apparatus 100 may append the threshold values to the previously stored performance characteristic values. If the user input includes the selection of a particular compiler options configuration, then the example apparatus 100 may overwrite a previously used compiler options configuration with the recently selected compiler options configuration. For example, if the source code obtained at block 402 is associated with a software development project having a compiler options configuration stored in the project configurations database 111d (FIG. 1B), changes made to the source code since the last build or compilation (e.g. the last nightly build) may render the stored compiler options configuration incapable of causing the example apparatus 100 to generate acceptable object code. In this case, the example apparatus 100 may overwrite or update the stored compiler options configuration with an updated or new compiler options configuration that causes the example apparatus 100 to generate acceptable object code based on the updated or changed source code. These are merely example ways in which the example apparatus 100 may update or generate information in the database repository 110. Of course, the example apparatus 100 may be configured to update or generate any other type of compiler-related information periodically and/or continuously as new data is generated.

After the example apparatus 100 generates or updates database information, the example apparatus 100 determines whether to recompile the source code 103 based on the user-defined input (block 430). For example, if the example apparatus 100 outputs a message at block 424 indicating that an acceptable object code was generated, the example apparatus 100 may obtain that object code from, for example, the database repository 110 or any other memory space and provide it to the user. If the user-defined input obtained at block 426 includes updated target performance characteristic values, the example apparatus 100 may repeat the compilation process (e.g., return control to block 408 of FIG. 4) to attempt to generate object code having performance characteristic values that are substantially similar to, equal to, or better than the updated target performance characteristic values. If the example apparatus 100 determines at block 430 that it should recompile the source code 103 based on the user-defined input, control is returned to block 408. Otherwise, the example apparatus 100 provides the object code to the user and the program ends.

FIG. 5 is a flowchart representative of machine readable instructions that may be executed to implement the object code profiler 108 of FIG. 1A. The flowchart of FIG. 5 describes in greater detail the machine readable instructions used to implement the operation of block 412 of FIG. 4. Initially, the object code profiler 108 determines the structural characteristics of the object code 107 (FIG. 1A) (block 502). In the illustrated example, the object code profiler 108 obtains the object code 107 from the compiler engine 106 (FIG. 1A) and analyzes the object code 107 to determine object code structural characteristics (e.g., instruction types, loop operations, type casting, pointer types, etc.).

An execution engine in the object code profiler 108 then executes the object code 107 (block 504). During or after execution of the object code 107, the object code profiler 108 determines run-time performance characteristics of the object code 107 (block 506). For example, the object code profiler 108 may measure execution time of one or more functions or sections of the object code 107. The object code profiler 108 may also determine system resource related performance characteristics such as, for example, required stack size, required registers, cache usage, etc.

The object profiler 108 then stores the structural characteristics and run-time performance characteristics of the object code 107 in the database repository 110 (FIG. 1A) (block 508). For example, object code profiler 108 may store the structural characteristics and run-time performance characteristics as structural characteristics and/or measured performance characteristics in a database, one or more database entries, or one or more database records corresponding to the compiler options configuration that the compiler engine 106 used to generate the object code 107. Control is then returned or passed to a calling function or process. For example, control may be passed to the operation of block 414 of FIG. 4.

FIG. 6 is a flowchart representative of machine readable instructions that may be executed to implement the performance analyzer 114 and the compiler options selector 120 of FIG. 1A. The flowchart of FIG. 6 describes in greater detail the machine readable instructions used to implement the operation of block 418 of FIG. 4. Initially, the performance analyzer 114 obtains target performance characteristic values, measured performance characteristic values, and structural characteristics of the source code 103 (FIG. 1A) and object code 107 (FIG. 1A) from the database repository 110 (FIG. 1A) (block 602). The performance analyzer 114 may then determine the performance differences between the target performance characteristic values and the measured performance characteristic values (block 604). For example, the performance analyzer 114 may determine percentage differences between the target and measured characteristic values as described above in connection with Equations 3 and 4 above.

The compiler options selector 120 then selects a compiler options configuration (block 606). In the illustrated example, the compiler options selector 120 selects a compiler options configuration based on empirical data stored in the empirical corollary database 111e (FIG. 1B) that correlates compiler options to target and measured performance characteristic values, performance differences, and structural characteristics of the source code and object code. In addition, the compiler options selector 120 may select a compiler options configuration based on tables generated by the table generator 116 (FIG. 1A). For example, the compiler options selector 120 may compare performances of compiler options configurations in the example compiler options performance comparison table 200 (FIG. 2) and compare rankings of compiler options configurations in the example compiler options configurations ranking table 300 (FIG. 3).

Alternatively, the compiler options selector 120 may select a compiler options configuration from the project configurations database 111d (FIG. 1B). For example, during an initial project build for a software development project, the example apparatus 100 may generate a compiler options configuration that meets or exceeds target performance characteristics (e.g., compile time, execution time, etc.) for that project and store the compiler options configuration in the project configurations database 111d. In this case, during subsequent builds or compilations, the compiler options selector 120 may retrieve the compiler options configuration from the project configurations database 111d. Control is then returned or passed to a calling function or process. For example, control may be passed to the operation of block 420 of FIG. 4.

FIG. 7 is a flowchart representative of machine readable instructions that may be executed to implement the performance analyzer 114 and the table generator 116 of FIG. 1A. The flowchart of FIG. 7 describes in greater detail the machine readable instructions used to implement the operation of block 420 of FIG. 4. Initially, the performance analyzer 114 obtains first and second sets of measured performance characteristic values (block 702). For example, after the compiler engine 106 has generated at least first and second object code files by compiling the source code 103 based on first and second compiler options configurations, and after the object code profiler 108 has generated a plurality of measured performance characteristic values, the performance analyzer 114 obtains a first set of measured performance characteristic values associated with the first object code and a second set of measured performance characteristic values associated with the second object code. If a user specifies that the example apparatus 100 should rank the compiler options configurations based on execution time and code size, the first set of measured performance characteristic values may include a first execution time characteristic value and first object code size corresponding to the first object code. The second set of measured performance characteristic values may include a second execution time characteristic value and a second object code size characteristic value corresponding to the second object code.

The performance analyzer 114 then obtains a baseline performance characteristic value (block 704). As described above in connection with Equation 5, the compiler options configurations are ranked based on an improvement or performance difference between a measured characteristic for baseline object code and the measured characteristic for subsequently compiled object code. For example, if the user specifies that the compiler options configurations should be ranked based on improvements or performance differences in execution time, then the performance analyzer 114 obtains from the database repository 110 a baseline execution time characteristic value associated with baseline object code.

The performance analyzer 114 then generates a first ratio based on the first set of measured performance characteristic values (block 706). For example, the performance analyzer 114 may generate the first ratio based on the first execution time characteristic value and the first object code size characteristic value obtained at block 702 and the baseline execution time characteristic value obtained at block 704 as described above in connection with Equation 5 and FIG. 3. The performance analyzer 114 then generates a second ratio based on the second set of measured performance characteristic values (block 708). For example, the performance analyzer 114 may generate the second ratio based on the second execution time characteristic value and the second object code size characteristic value obtained at block 702 and the baseline execution time characteristic value obtained at block 704 as described above in connection with Equation 5 and FIG. 3.

The table generator 116 (FIG. 1A) then obtains the compiler options configurations associated with the first and second sets of measured performance characteristic values (block 710). For example, the table generator 116 may obtain from the database repository 110, a first compiler options configuration associated with the first set of measured performance characteristic values and a second compiler options configuration associated with the second set of measured performance characteristic values. The table generator 116 may then assign first and second priority values to the first and second compiler options configurations based on the first and second ratios generated at blocks 706 and 708 (block 712). After assigning priority values to the first and second compiler options configurations, the table generator 116 sorts the first and second compiler options configurations and corresponding ratios (block 714) in the example compiler options configurations ranking table 300 based on the priority values assigned to each at block 712. The table generator 116 then stores the ranking table 300 in the database repository 110 (block 716). Control is then returned or passed to a calling function or process. For example, control may be passed to the operation of block 422 of FIG. 4.

FIG. 8 is another flowchart representative of machine readable instructions that may be executed to implement the performance analyzer 114 and the table generator 116 of FIG. 1A. The flowchart of FIG. 8 describes the machine readable instructions used to implement the operation of block 422 of FIG. 4. Initially, the performance analyzer 114 obtains target performance characteristic values, measured performance characteristic values, and corresponding compiler options configurations from the database repository 110 (block 802).

The performance analyzer 114 then obtains performance differences between the target performance characteristic values and the measured performance characteristic values (block 804). For example, the performance analyzer 114 may determine percentage differences or percentage errors based on the target and measured characteristic values obtained at block 802 as described above in connection with Equations 3 and 4.

The table generator 116 then obtains the compiler options configurations associated with the performance differences generated at block 804 from the database repository 110 (block 806). The table generator 116 then generates a comparison table based on the compiler options configurations obtained at block 806 and corresponding performance differences generated at block 804 (block 808). More specifically, the table generator 116 stores the compiler options configurations and corresponding performance differences in the example compiler options performance comparison table 200 as described above in connection with FIG. 2.

The table generator 116 then stores the comparison table generated at block 808 in the database repository 110 (block 810). Control is then returned or passed to a calling function or process. For example, control may be passed to the operation of block 424 of FIG. 4.

FIG. 9 is a block diagram of an example processor system that may be used to implement the systems and methods described herein. As shown in FIG. 9, the processor system 910 includes a processor 912 that is coupled to an interconnection bus 914. The processor 912 includes a register set or register space 916, which is depicted in FIG. 9 as being entirely on-chip, but which could alternatively be located entirely or partially off-chip and directly coupled to the processor 912 via dedicated electrical connections and/or via the interconnection bus 914. The processor 912 may be any suitable processor, processing unit or microprocessor. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. As is well known, a chipset typically provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a DSL modem, a cable modem, a cellular modem, etc. that enables the processor system 910 to communicate with another processor system.

While the memory controller 920 and the I/O controller 922 are depicted in FIG. 9 as separate functional blocks within the chipset 918, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of compiling software, comprising:
a) receiving target performance characteristics from a user;
b) compiling source code to generate object code;
c) analyze the object code to determine measured performance characteristics;
d) comparing the measured performance characteristics to the target performance characteristics;
e) if the measured performance characteristics are unacceptable based on the target performance characteristics, selecting one of a plurality of compiler options configurations based on empirical data correlating the compiler options configurations to structural characteristics of at least one of the source code or the object code;
f) repeating b-f using the selected one of the plurality of compiler options configurations and without obtaining further user input until the measured performance characteristics are substantially equal to the target performance characteristics or until a predetermined number of recompilations have occurred.

2. A method as defined in claim 1, wherein the target performance characteristics are associated with at least one of a compilation time, a stack size, a heap size, a binary size, or an execution time.

3. A method as defined in claim 1, wherein the measured performance characteristics are unacceptable based on the target performance characteristics if the measured performance characteristics are not substantially equal to or better than the target performance characteristics.

4. A method as defined in claim 1, further comprising retrieving the empirical data from a database, wherein the empirical data is generated based on previous compilations and includes ranking information associated with the measured performance characteristics.

5. A method as defined in claim 1, further comprising selecting the one of the plurality of compiler options configurations based on performance differences between the target performance characteristics and the measured performance characteristics.

6. A method as defined in claim 1, further comprising outputting at least some of the plurality of compiler options configurations based on the target performance characteristics and the measured performance characteristics.

7. A method as defined in claim 1, further comprising ranking the plurality of compiler options configurations based on the target performance characteristics and the measured performance characteristics.

8. A method as defined in claim 7, wherein ranking the plurality of compiler options configurations comprises:
generating priority values based on ratios generated using the measured performance characteristics; and
ranking the plurality of compiler options configurations based on the priority values.

9. A method as defined in claim 7, further comprising selecting the one of the plurality of compiler options configurations based on the ranking of the plurality of compiler options configurations.

10. A method as defined in claim 7, further comprising outputting the ranking of the plurality of the compiler options configurations.

11. A method as defined in claim 1, wherein the target performance characteristics are associated with tolerance values.

12. An apparatus for compiling software, comprising:
a source code interface to receive target performance characteristics from a user;
a compiler engine to compile source code to generate object code;
an object code profiler to analyze the object code to determine measured performance characteristics;
a performance analyzer to compare the measured performance characteristics to the target performance characteristics; and
a compiler options selector to select one of a plurality of compiler options configurations based on empirical data correlating the compiler options configurations to structural characteristics of at least one of the source code or the object code, wherein the compiler engine, without further user input, recompiles the source code a plurality of times based on a corresponding plurality of compiler options configurations selected by the compiler options selector to generate a plurality of object code until the measured performance characteristics are substantially equal to or better than the target performance characteristics or until a predetermined number of recompilations have occurred.

13. An apparatus as defined in claim 12, wherein the target performance characteristics are associated with at least one of a compilation time, a stack size, a heap size, a binary size, or an execution time.

14. An apparatus as defined in claim 12, wherein the compiler options selector is configured to retrieve the empirical data from a database, wherein the empirical data is generated based on previous compilations and includes ranking information associated with the measured performance characteristics.

15. An apparatus as defined in claim 12, wherein the compiler options selector is configured to select the one of the plurality of compiler options configurations based on performance differences between the target performance characteristics and the measured performance characteristics.

16. An apparatus as defined in claim 12, further comprising a table generator to create a table reflecting the plurality of compiler options configurations based on the target performance characteristics and the measured performance characteristics.

17. An apparatus as defined in claim 12, wherein the table generator creates a table ranking the plurality of the compiler options configurations.

18. An apparatus as defined in claim 12, wherein the performance analyzer is configured to analyze the target performance characteristics and the measured performance characteristics to rank the plurality of compiler options configurations.

19. An apparatus as defined in claim 12, wherein the performance analyzer generates priority values based on the measured performance characteristics, and wherein the priority values are associated with ranking the plurality of compiler options configurations.

20. An apparatus as defined in claim 12, wherein the compiler options selector selects one of the plurality of compiler options configurations based on rankings of the plurality of compiler options configurations.

21. An apparatus as defined in claim 12, wherein the target performance characteristics are associated with tolerance values.

22. A machine accessible medium having instructions stored thereon that, when executed, cause a machine to:
a) receive target performance characteristics from a user;
b) compile source code to generate object code;
c) analyze the object code to determine measured performance characteristics;
d) compare the measured performance characteristics to the target performance characteristics;
e) if the measured performance characteristics are unacceptable based on the target performance characteristics, select one of a plurality of compiler options configurations based on empirical data correlating the compiler options configurations to structural characteristics of at least one of the source code or the object code;
f) repeat b-f using the selected one of the plurality of compiler options configurations and without obtaining further user input until the measured performance characteristics are substantially equal to the target performance characteristics or until a predetermined number of recompilations have occurred.

23. A machine accessible medium as defined in claim 22, wherein, when executed, the instructions cause the machine to determine that the measured performance characteristics are unacceptable based on the target performance characteristics if the measured performance characteristics are not substantially equal to or better than the target performance characteristics.

24. A machine accessible medium as defined in claim 22, wherein the instructions stored thereon, when executed, cause the machine to select the one of the plurality of compiler options configurations based on performance differences between the target performance characteristics and the measured performance characteristics.

25. A machine accessible medium as defined in claim 22, wherein the instructions stored thereon, when executed, cause the machine to rank the plurality of compiler options configurations based on the target performance characteristics and the measured performance characteristics.
